(19) United States
(12) Patent Application Publication
(10) Pub. No.: US 2018/0359389 A1
(43) Pub. Date: Dec. 13, 2018

(54) Image Forming Apparatus That Reduces Stored Account Information, and Authentication Method Executed by The Same

(71) Applicant: Kyocera Document Solutions Inc., Osaka (JP)

(72) Inventor: Kiyoshi Hori, Osaka (JP)

(21) Appl. No.: 16/006,812

(22) Filed: Jun. 12, 2018

(30) Foreign Application Priority Data
Jun. 12, 2017 (JP) 2017-115012

(51) Int. Cl. H04N 1/44; H04N 1/00

(52) U.S. Cl. CPC H04N 1/4413; H04N 1/00925; H04N 1/00411

(57) ABSTRACT

An image forming apparatus includes an operation panel and a storage unit. The storage unit stores first account information. The accepting unit accepts second account information from the operation panel or the terminal device. The authentication unit performs user authentication based on the first account information and the second account information. The inhibition unit inhibits acceptance of the second account information by the accepting unit when a count where the user authentication has continuously failed is equal to or more than an upper limit count. The upper limit count includes a first count and a second count. The first count indicates the upper limit count where the accepting unit accepts the second account information from the operation panel. The second count indicates the upper limit count where the accepting unit accepts the second account information from the terminal device. The first count is different from the second count.

### INCORPORATION BY REFERENCE

This application is based upon, and claims the benefit of priority from, corresponding Japanese Patent Application No. 2017-115012 filed in the Japan Patent Office on Jun. 12, 2017, the entire contents of which are incorporated herein by reference.

### BACKGROUND

Unless otherwise indicated herein, the description in this section is not prior art to the claims in this application and is not admitted to be prior art by inclusion in this section.

There is proposed a following authentication method. When a user authentication using a first password continuously fails equal to or more than an allowable count, a user is set to “a password-change required state.” The term of “the password-change required state” means a state where the first password needs to be changed. Then, when the user in “the password-change required state” enters a correct first password, the user is prompted to enter a second password and the changed first password. When the entered second password is correct, the first password of the user is changed to the changed first password.

### SUMMARY

An image forming apparatus according to one aspect of the disclosure is communicatively connected to a terminal device. The image forming apparatus includes an operation panel and a storage unit. The storage unit stores first account information. The accepting unit accepts second account information from the operation panel or the terminal device. The authentication unit performs a user authentication based on the first account information and the second account information. The inhibition unit inhibits an acceptance of the second account information by the accepting unit when a count where the user authentication has continuously failed is equal to or more than an upper limit count. The upper limit count includes a first count and a second count. The first count indicates the upper limit count where the accepting unit accepts the second account information from the operation panel. The second count indicates the upper limit count where the accepting unit accepts the second account information from the terminal device. The first count is different from the second count.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a connection state between an image forming apparatus and personal computers according to one embodiment of the disclosure.

FIG. 2 illustrates a configuration of the image forming apparatus according to the one embodiment.

FIG. 3 illustrates a configuration of a control unit according to the one embodiment.

FIG. 4 illustrates an exemplary authentication screen that is displayed on a touch panel according to the one embodiment.

FIG. 5 illustrates an exemplary authentication screen, which is different from FIG. 4 and is displayed on the touch panel, according to the one embodiment.

FIG. 6 illustrates an exemplary authentication screen that is displayed in the personal computer according to the one embodiment.

FIG. 7 illustrates one example of processes of the control unit according to the one embodiment.

FIG. 8 illustrates one example of the processes of the control unit according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

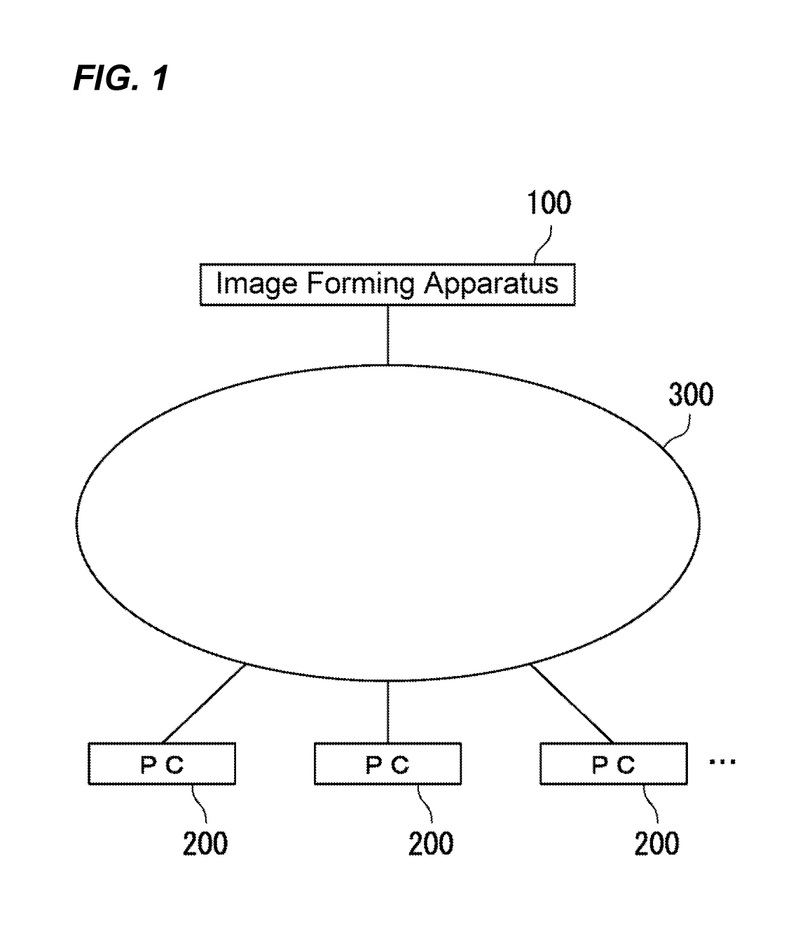

The following describes an embodiment of the disclosure with reference to the drawings (FIGS. 1 to 8). In the drawings, identical reference numerals are used to the identical or corresponding parts not to repeat explanations.

First, with reference to FIG. 1, a description will be given of a connection state between an image forming apparatus 100 and personal computers 200 according to the embodiment of the disclosure. As illustrated in FIG. 1, the image forming apparatus 100 is communicatively connected to the plurality of personal computers (PCs) 200 via a network 300.

The image forming apparatus 100 is, what is called, a multi-functional peripheral, and has a communication function. The image forming apparatus 100 transmits and receives various kinds of information to/from the personal computers 200 via the network 300.

The personal computers 200 have a communication function. The personal computers 200 correspond to one example of “a terminal device.” The plurality of personal computers 200 have configurations approximately identical with one another, and thus, in the following description, will be sometimes described as the personal computer 200 as a generic term.

The network 300 is, for example, the Internet. The network 300 is not limited to the Internet. The network 300 may be configured as a local area network (LAN), or the network 300 may be configured as a wide area network (WAN).

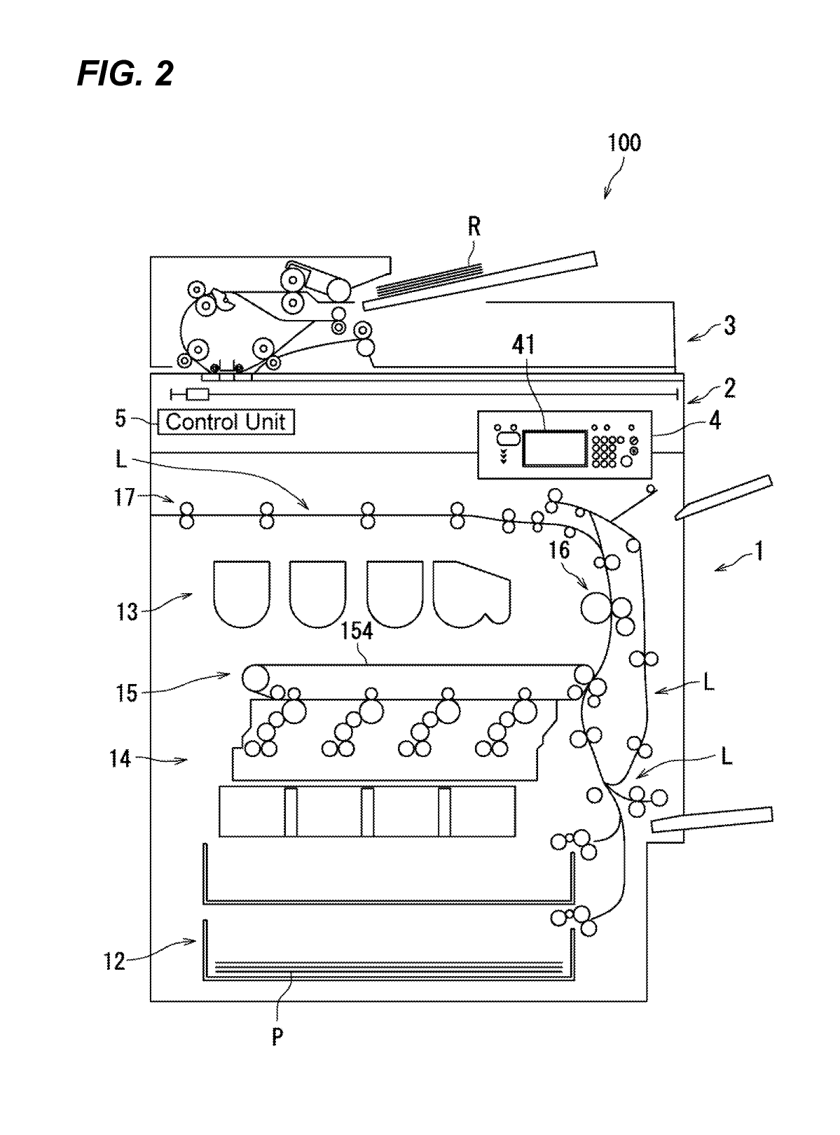

Next, with reference to FIGS. 1 and 2, a description will be given of a configuration of the image forming apparatus 100 according to the embodiment. FIG. 2 illustrates the configuration of the image forming apparatus 100. The image forming apparatus 100 is a color multi-functional peripheral. The image forming apparatus 100 reads an image formed on a document R and forms the image on a paper sheet P using toner.

As illustrated in FIG. 2, the image forming apparatus 100 includes an image forming unit 1, an image reading unit 2, a document conveyance unit 3, an operation panel 4, and a control unit 5. The image forming unit 1 forms an image on the paper sheet P. The image reading unit 2 reads an image formed on the document R to generate image information. The document conveyance unit 3 conveys the document R to the image reading unit 2. The operation panel 4 accepts an operation from a user. The control unit 5 controls operations of the image forming apparatus 100.

The image forming unit 1 includes a feeding unit 12, a conveying unit L, a toner supplying unit 13, an image forming unit 14, a fixing unit 16, and a discharge unit 17. The image forming unit 14 includes a transfer unit 15.

The feeding unit 12 supplies the conveying unit L with the paper sheet P. The conveying unit L conveys the paper sheet P up to the discharge unit 17 via the transfer unit 15 and the fixing unit 16.

The toner supplying unit 13 supplies the image forming unit 14 with toner. The image forming unit 14 forms an image onto the paper sheet P.

The transfer unit 15 includes an intermediate transfer belt 154. The image forming unit 14 transfers toner images of cyan color, magenta color, yellow color, and black color on the intermediate transfer belt 154. A plurality of colors of toner images are superimposed on the intermediate transfer belt 154 to form an image on the intermediate transfer belt 154. The transfer unit 15 transfers the image formed on the intermediate transfer belt 154 onto the paper sheet P. As a result, the image is formed on the paper sheet P.

The fixing unit 16 heats and pressurizes the paper sheet P to fix the image, which is formed on the paper sheet P, to the paper sheet P. The discharge unit 17 discharges the paper sheet P outside the image forming apparatus 100.

The operation panel 4 includes a touch panel 41. The touch panel 41 includes, for example, a liquid crystal display (LCD) and displays various kinds of images. The touch panel 41 includes a touch sensor to accept an operation from a user. The touch panel 41 is formed in a rectangular shape.

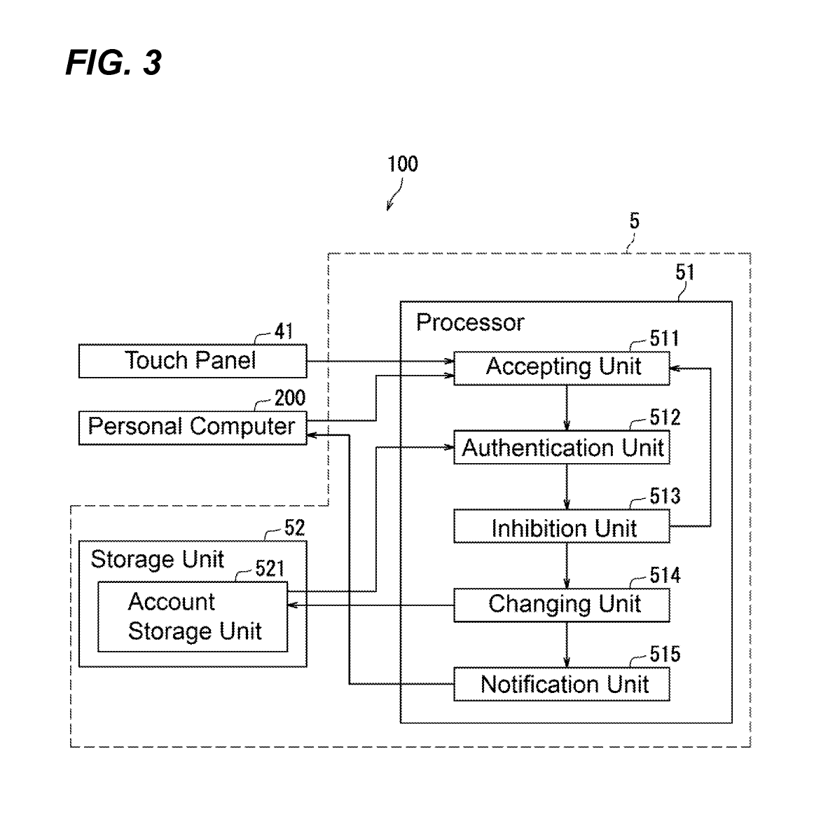

Next, with reference to FIGS. 1 to 3, a description will be given of a configuration of the control unit 5 according to the embodiment of the disclosure. FIG. 3 illustrates the configuration of the control unit 5.

As illustrated in FIG. 3, the control unit 5 includes a processor 51 and a storage unit 52. The processor 51 includes, for example, a central processing unit (CPU). The storage unit 52 includes a memory such as a semiconductor memory and may include a hard disk drive (HDD). The storage unit 52 stores a control program.

The processor 51 includes an accepting unit 511, an authentication unit 512, an inhibition unit 513, a changing unit 514, and a notification unit 515. Specifically, the processor 51 functions as the accepting unit 511, the authentication unit 512, the inhibition unit 513, the changing unit 514, and the notification unit 515 by executing the control program. The storage unit 52 includes an account storage unit 521.

The account storage unit 521 stores first account information AC1. The account information indicates information that proves that a user has a right to log in to the image forming apparatus 100. In the embodiment of the disclosure, the account information is configured of user Identification (ID) information and password information. The user ID information means a piece of information that identifies a user. The password information means a piece of information that determines whether a user is the user that corresponds to the user ID information or not.

Specifically, the first account information AC1 is configured of first user ID information α1J and first password information β1J. The account storage unit 521 associates the first user ID information α1J with the first password information β1J to store them.

The accepting unit 511 accepts second account information AC2 from the touch panel 41 or the personal computer 200. The second account information AC2 is configured of second user ID information α2J and second password information β2J.

The authentication unit 512 performs a user authentication based on the first account information AC1 and the second account information AC2. Specifically, the authentication unit 512 determines whether the first user ID information α1J that matches the second user ID information α2J is stored in the account storage unit 521 or not. When the first user ID information α1J that matches the second user ID information α2J is not stored in the account storage unit 521, the user authentication fails. When the first user ID information α1J that matches the second user ID information α2J is stored in the account storage unit 521, the authentication unit 512 performs the user authentication based on whether the second password information β2J matches the first password information β1J, which corresponds to the first user ID information α1J, or not. When the second password information β2J matches the first password information β1J, the user authentication succeeds. When the second password information β2J does not match the first password information β1J, the user authentication fails.

When a count NF where the user authentication has continuously failed, is equal to or more than an upper limit count NFA, the inhibition unit 513 inhibits an acceptance of the second account information AC2 by the accepting unit 511. The upper limit count NFA includes a first count NF1 and a second count NF2. The first count NF1 means an upper limit count NFA where the accepting unit 511 accepts the second account information AC2 from the touch panel 41. The second count NF2 means an upper limit count NFA where the accepting unit 511 accepts the second account information AC2 from the personal computer 200. The first count NF1 is different from the second count NF2. Specifically, the first count NF1 is larger than the second count NF2. For example, the first count NF1 is 100 times, and the second count NF2 is three times.

When the inhibition unit 513 inhibits the acceptance of the second account information AC2 by the accepting unit 511, the changing unit 514 changes password information to new password information.

The notification unit 515 notifies the user corresponding to the first account information AC1 of the new password information.

As described above with reference to FIGS. 1 to 3, in the embodiment of the disclosure, when the count NF, where the user authentication has continuously failed, is equal to or more than the upper limit count NFA, the inhibition unit 513 inhibits the acceptance of the second account information AC2 by the accepting unit 511. The upper limit count NFA includes the first count NF1 and the second count NF2. The first count NF1 means an upper limit count NFA where the accepting unit 511 accepts the second account information AC2 from the touch panel 41. The second count NF2 means an upper limit count NFA where the accepting unit 511 accepts the second account information AC2 from the personal computer 200. The first count NF1 is different from the second count NF2. Accordingly, for example, setting the first count NF1 to a very large count (such as 100 times) cannot lead to a case where the inhibition unit 513 inhibits the acceptance of the second account information AC2 by the accepting unit 511. Consequently, the changing unit 514 does not change the password information. Therefore, this ensures the reduced frequency of storing new password information by a user.

When the second account information AC2 is accepted from the touch panel 41, an erroneous input is likely to occur at the accepting unit 511. Accordingly, for example, setting the first count NF1 to a very large count cannot lead to a case where the inhibition unit 513 inhibits the acceptance of the second account information AC2 by the accepting unit 511. Consequently, the changing unit 514 does not change the password information. Therefore, this surely ensures the reduced frequency of storing new password information by a user.

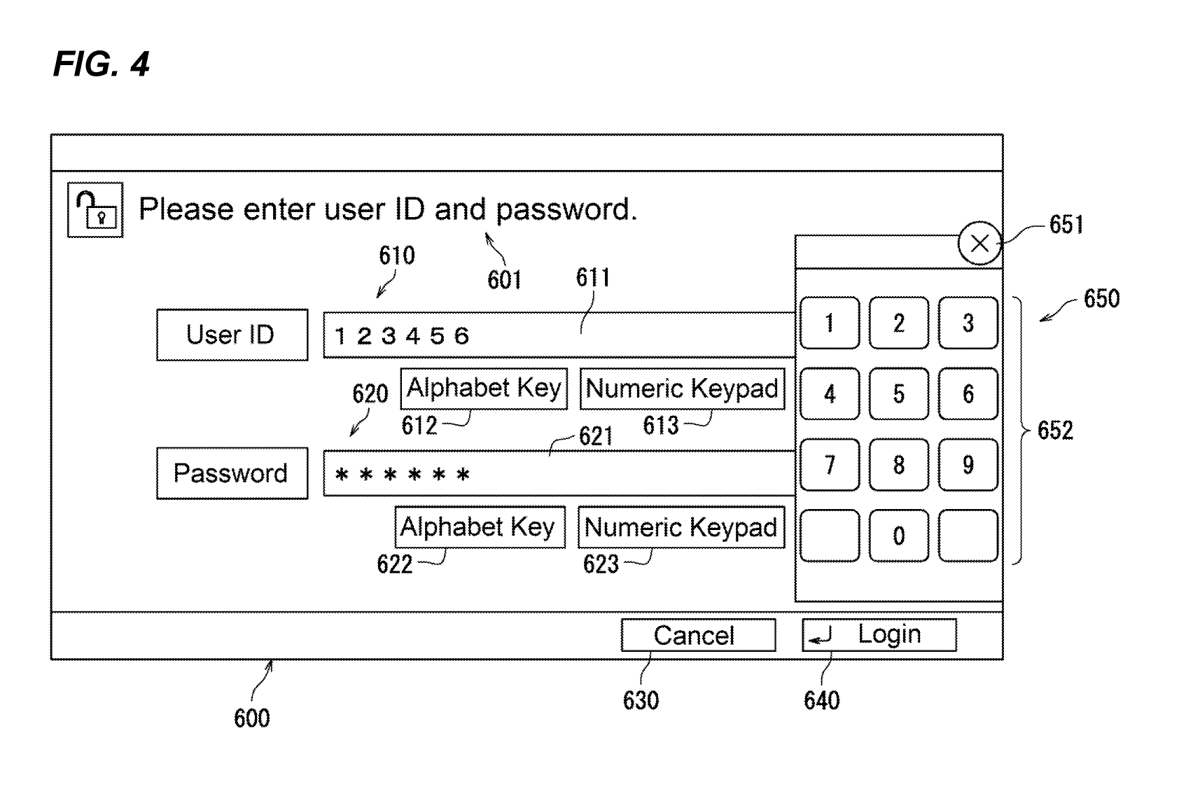

Next, with reference to FIGS. 2 to 4, a description will be given of an authentication screen 600. FIG. 4 illustrates an exemplary authentication screen 600 displayed on the touch panel 41. As illustrated in FIG. 4, a message display 601, a user ID input portion 610, a password input portion 620, a cancel button 630, a login button 640, and a first on-screen keyboard 650 are displayed on the authentication screen 600. The accepting unit 511 displays the authentication screen 600 on the touch panel 41.

The message display 601 displays a message that prompts the user to enter a second user ID α2 and a second password β2. The second user ID α2 corresponds to the second user ID information α2J. The second password β2 corresponds to the second password information β2J. For example, the message display 601 displays a character string: “Please enter user ID and password.”

The user ID input portion 610 accepts the second user ID α2 to display the second user ID α2. The user ID input portion 610 includes a user ID display 611, an alphabet-key display button 612, and a numeric-keypad display button 613.

The user ID display 611 displays the second user ID α2 entered via an on-screen keyboard. The on-screen keyboard includes alphabet keys and a numeric keypad.

When the alphabet is entered as the second user ID α2, the alphabet-key display button 612 is indicated as a button for the user to touch. When the user touches the alphabet-key display button 612, the accepting unit 511 displays an on-screen keyboard that indicates alphabet keys on the touch panel 41.

When a numeral is entered as the second user ID α2, the numeric-keypad display button 613 is indicated as a button for the user to touch. When the user touches the numeric-keypad display button 613, the accepting unit 511 displays the first on-screen keyboard 650 that indicates the numeric keypad on the touch panel 41.

The password input portion 620 accepts the second password β2 to display the second password β2. The password input portion 620 includes a password display 621, an alphabet-key display button 622, and a numeric-keypad display button 623.

The password display 621 displays the second password β2 entered via the on-screen keyboard. The on-screen keyboard includes the alphabet keys and the numeric keypad.

When the alphabet is entered as the second password β2, the alphabet-key display button 622 is indicated as a button for the user to touch. When the user touches the alphabet-key display button 622, the accepting unit 511 displays the on-screen keyboard that indicates the alphabet keys on the touch panel 41.

When a numeral is entered as the second password β2, the numeric-keypad display button 623 is indicated as a button for the user to touch. When the user touches the numeric-keypad display button 623, the accepting unit 511 displays the first on-screen keyboard 650 that indicates the numeric keypad on the touch panel 41.

When the second user ID α2 displayed on the user ID display 611 and the second password β2 displayed on the password display 621 are canceled, the cancel button 630 is indicated as a button for the user to touch. When the user touches the cancel button 630, the accepting unit 511 deletes the second user ID α2 displayed on the user ID display 611 and the second password β2 displayed on the password display 621.

In a login by the second user ID α2 displayed on the user ID display 611 and the second password β2 displayed on the password display 621, the login button 640 is indicated as a button for the user to touch. When the user touches the login button 640, the authentication unit 512 performs the user authentication. Specifically, when the second user ID α2 matches a first user ID α1, the authentication unit 512 performs the user authentication corresponding to whether the second password β2 matches a first password β1 or not. The first password β1 corresponds to the first user ID α1.

The first on-screen keyboard 650 includes a delete button 651 and a numeric keypad 652. Touching the numeric-keypad display button 613 or the numeric-keypad display button 623 causes the accepting unit 511 to display the first on-screen keyboard 650. Specifically, the first on-screen keyboard 650 is displayed at an end portion on one side of the touch panel 41. For example, the first on-screen keyboard 650 is displayed in close proximity to a short side on one side (for example, the right side) of the touch panel 41.

When the first on-screen keyboard 650 is deleted, the delete button 651 is indicated as a button for the user to touch. When the user touches the delete button 651, the accepting unit 511 deletes the first on-screen keyboard 650.

The numeric keypad 652 includes keys that indicate the numerals of 0 to 9. Touching the numeric keypad 652 causes the accepting unit 511 to display the numerals corresponding to the touched keys on the user ID display 611 or the password display 621. Specifically, when the numeric-keypad display button 613 is touched to display the first on-screen keyboard 650, the accepting unit 511 causes the user ID display 611 to display the numerals corresponding to the touched keys. Touching the numeric-keypad display button 623 to display the first on-screen keyboard 650 causes the accepting unit 511 to display the numerals corresponding to the touched keys on the password display 621.

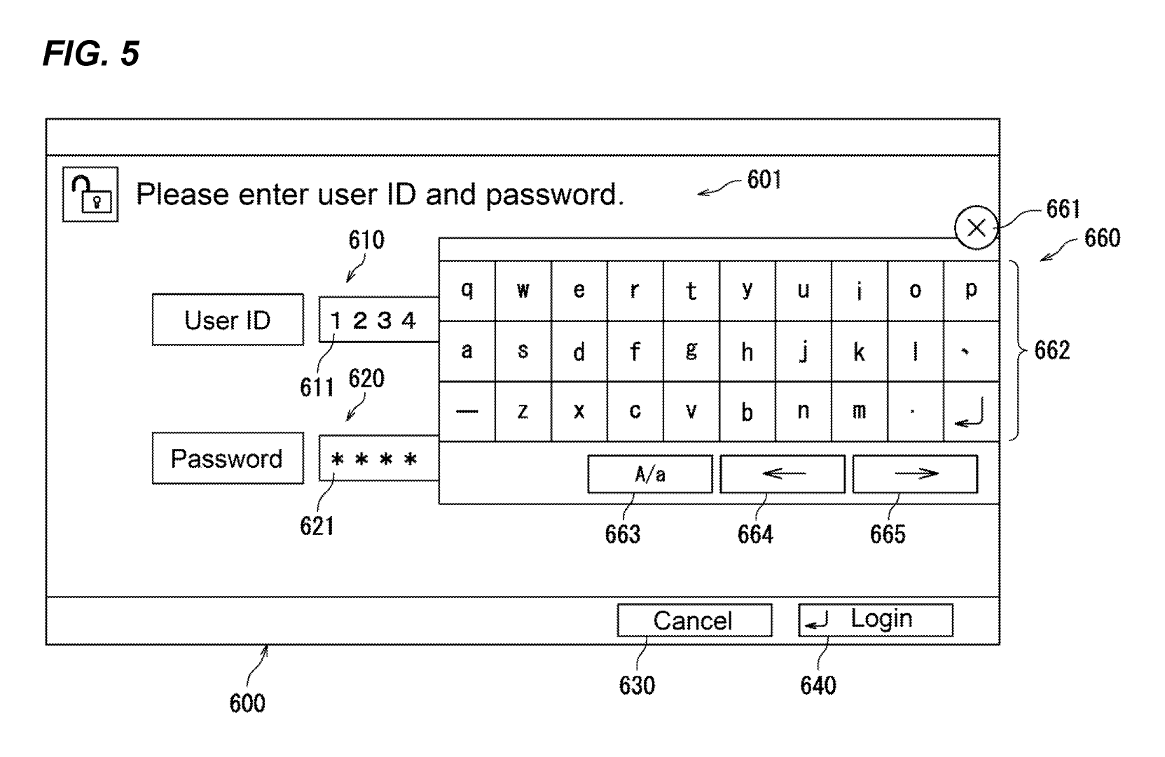

Next, with reference to FIGS. 2 to 5, a description will be further given of the authentication screen 600. FIG. 5 illustrates an exemplary authentication screen 600, which is different from FIG. 4, displayed on the touch panel 41. While the first on-screen keyboard 650 in the authentication screen 600 illustrated in FIG. 4 includes the numeric keypad 652, a second on-screen keyboard 660 in the authentication screen 600 illustrated in FIG. 5 is different from the first on-screen keyboard 650 in that the second on-screen keyboard 660 includes alphabet keys 662. The following mainly describes the points different from the authentication screen 600 illustrated in FIG. 4.

As illustrated in FIG. 5, the message display 601, the user ID input portion 610, the password input portion 620, the cancel button 630, the login button 640, and the second on-screen keyboard 660 are displayed on the authentication screen 600.

The second on-screen keyboard 660 includes a delete button 661, the alphabet keys 662, a capital- and small-letters conversion button 663, a return button 664, and a forward button 665. When the alphabet-key display button 612 or the alphabet-key display button 622 illustrated in FIG. 4 is touched, the second on-screen keyboard 660 is displayed by the accepting unit 511. Specifically, the second on-screen keyboard 660 is displayed at an end portion on one side of the touch panel 41. For example, the second on-screen keyboard 660 is displayed in close proximity to the short side on one side (for example, the right side) of the touch panel 41.

When the second on-screen keyboard 660 is deleted, the delete button 661 is indicated as a button for the user to touch. When the user touches the delete button 661, the accepting unit 511 deletes the second on-screen keyboard 660.

The alphabet keys 662 include the keys that indicate the alphabetic letters A to Z. When the alphabet keys 662 are touched, the accepting unit 511 causes the user ID display 611 or the password display 621 to display the alphabetic letters corresponding to the touched keys. Specifically, touching the alphabet-key display button 612 to display the second on-screen keyboard 660 causes the accepting unit 511 to display the alphabetic letters corresponding to the touched keys on the user ID display 611. Touching the alphabet-key display button 622 to display the second on-screen keyboard 660 causes the accepting unit 511 to display the alphabetic letters corresponding to the touched keys on the password display 621.

When a capital letter and a small letter are converted to one another, the capital- and small-letters conversion button 663 is indicated as a button for the user to touch. When the user touches the capital- and small-letters conversion button 663, the accepting unit 511 converts the alphabetic letter, which is displayed on the user ID display 611 or the password display 621 corresponding to the touch on the alphabet keys 662, from the small letter to the capital letter (or from the capital letter to the small letter).

When returning the input position in the user ID display 611 or the password display 621 by one letter, the return button 664 is indicated as a button for the user to touch. When the user touches the return button 664, the accepting unit 511 returns the position of the alphabetic letter, which is displayed on the user ID display 611 or the password display 621 corresponding to the touch on the alphabet keys 662, by one letter. Specifically, the accepting unit 511 moves the positions of the alphabetic letters displayed on the user ID display 611 or the password display 621 to the left side by one letter.

When input positions into the user ID display 611 or the password display 621 are moved forward by one letter, the forward button 665 is indicated as a button for the user to touch. Touching the forward button 665 by the user causes the accepting unit 511 to move forward the positions of the alphabetic letters, which are displayed on the user ID display 611 or the password display 621 corresponding to the touch on the alphabet keys 662, by one letter. Specifically, the accepting unit 511 moves the positions of the alphabetic letters displayed on the user ID display 611 or the password display 621 to the right side by one letter.

As described above with reference to FIGS. 2 to 5, in the embodiment of the disclosure, when the accepting unit 511 accepts the second user ID α2 and the second password β2 from the touch panel 41, the accepting unit 511 accepts the second user ID α2 and the second password β2 via the on-screen keyboard. The on-screen keyboard corresponds to the first on-screen keyboard 650 and the second on-screen keyboard 660. Due to displaying the on-screen keyboard inside the touch panel 41, the on-screen keyboard cannot be displayed in a sufficient size, and thus an erroneous input is more likely to occur. Accordingly, for example, it is preferable to set the first count NF1 at a very large count (such as 100 times). Thus, setting the first count NF1 at a very large count cannot lead to a case where the inhibition unit 513 inhibits the acceptance of the second user ID α2 and the second password β2 by the accepting unit 511. Consequently, the changing unit 514 does not change the password information. Therefore, this ensures the reduced frequency of storing new password information by the user.

In the embodiment of the disclosure, while the inhibition unit 513 inhibits the acceptance of the second account information AC2 by the accepting unit 511 when the count NF, where the user authentication has continuously failed, is equal to or more than the upper limit count NFA, the disclosure is not limited to this. When the accepting unit 511 accepts the second account information AC2 from the touch panel 41, the inhibition unit 513 may be configured to permit the acceptance of the second account information AC2 by the accepting unit 511. In this configuration, when the user enters the second account information AC2 from the touch panel 41, the inhibition unit 513 does not inhibit the acceptance of the second account information AC2 by the accepting unit 511 no matter how many times the second account information AC2 is erroneously entered. Therefore, because the first account information AC1 needs not to be changed, this further surely ensures the reduced frequency of storing new first account information AC1 by the user.

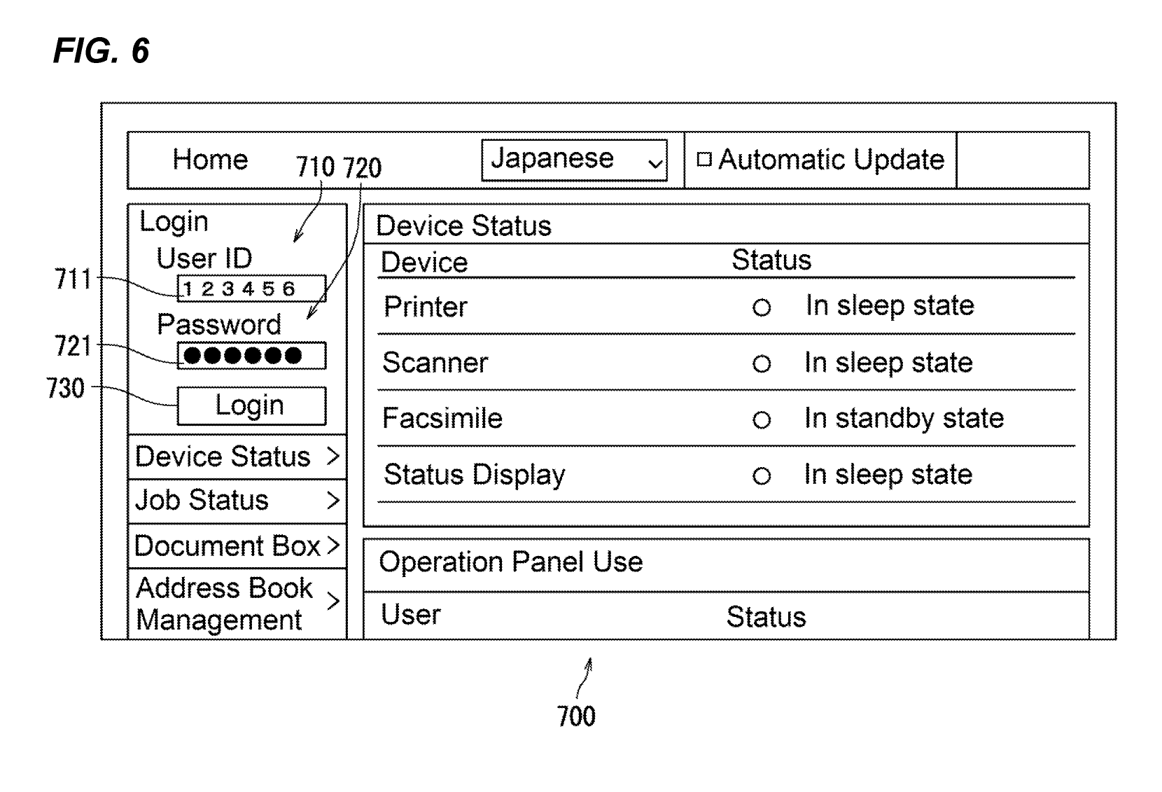

Next, with reference to FIG. 1 and FIGS. 3 to 6, a description will be given of an authentication screen 700 displayed on the personal computer 200. FIG. 6 illustrates an exemplary authentication screen 700 displayed on the personal computer 200. As illustrated in FIG. 6, a user ID input portion 710, a password input portion 720, and a login button 730 are displayed on the authentication screen 700. The personal computer 200 includes, for example, a keyboard and a computer mouse. The keyboard includes alphabet keys and a numeric keypad.

The user ID input portion 710 includes a user ID display 711. On the user ID display 711, the accepting unit 511 displays the second user ID α2 entered via the keyboard.

The password input portion 720 includes a password display 721. On the password display 721, the accepting unit 511 displays the second password β2 entered via the keyboard.

In a login by the second user ID α2 displayed on the user ID display 711 and the second password β2 displayed on the password display 721, the login button 730 is indicated as a button for the user to touch. When the user clicks the login button 730, the authentication unit 512 performs the user authentication. Specifically, when the second user ID α2 matches the first user ID α1, the authentication unit 512 performs the user authentication corresponding to whether the second password β2 matches the first password β1 or not. The first password β1 corresponds to the first user ID α1.

As described above with reference to FIG. 1 and FIGS. 3 to 6, in the embodiment of the disclosure, when the accepting unit 511 accepts the second user ID α2 and the second password β2 from the personal computer 200, the accepting unit 511 accepts the second user ID α2 and the second password β2 via the keyboard. Accordingly, for example, it is preferable to set the second count NF2 at a small count (such as three times) compared with the first count NF1. Thus, setting the second count NF2 at a small count ensures reduced access to the image forming apparatus 100 by a malicious user.

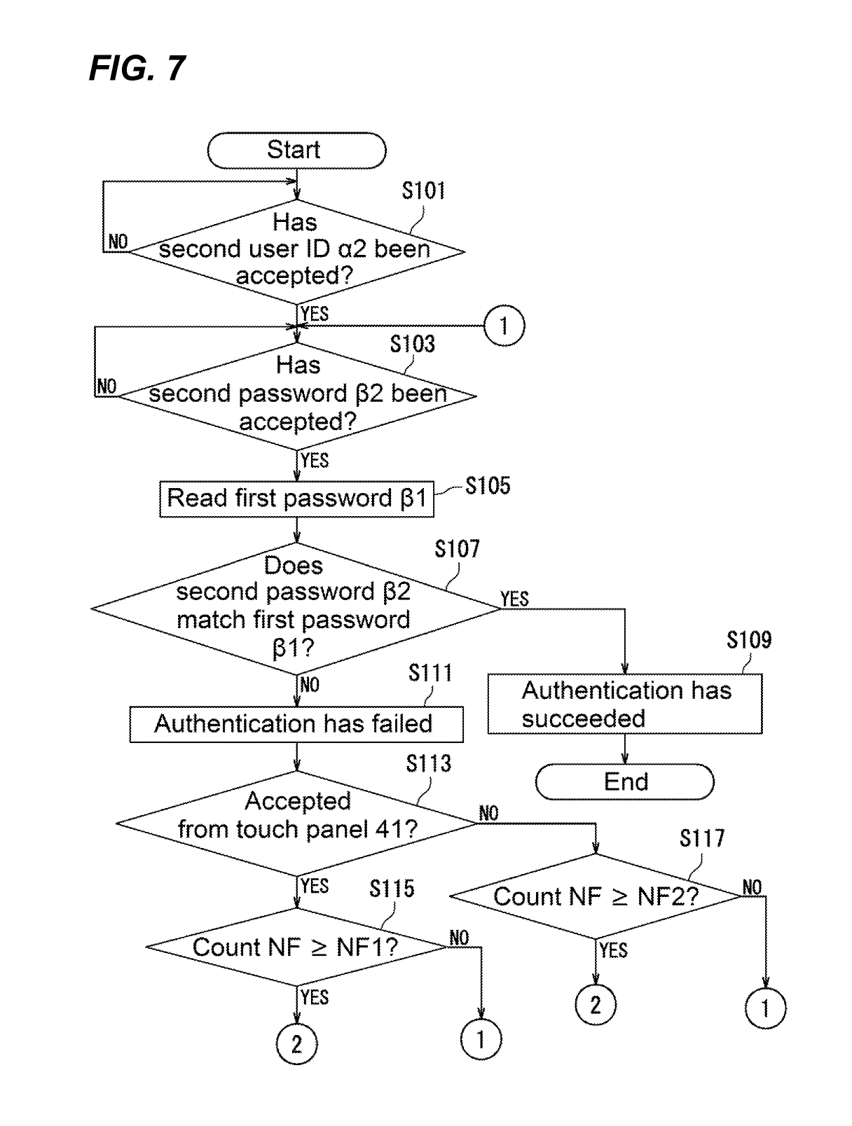

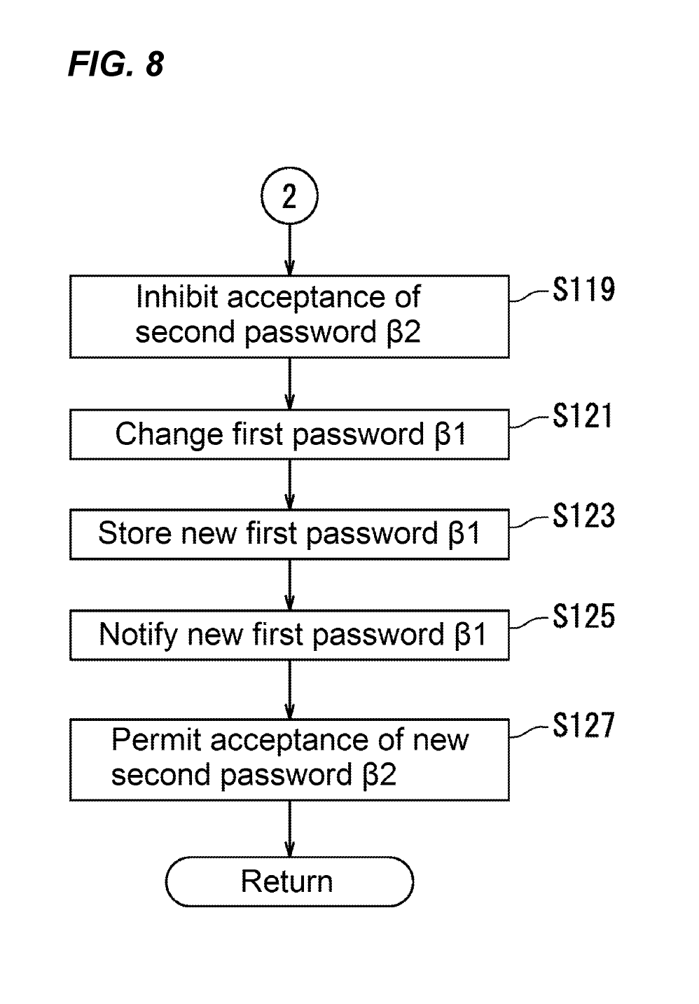

Next, with reference to FIGS. 1 to 8, a description will be given of processes of the control unit 5. FIGS. 7 and 8 illustrate one example of the processes of the control unit 5.

First, as illustrated in FIG. 7, at Step S101, the accepting unit 511 determines whether the second user ID α2 has been accepted or not.

When the accepting unit 511 has determined that the second user ID α2 has not been accepted (NO at Step S101), the process becomes a standby state. When the accepting unit 511 has determined that the second user ID α2 has been accepted (YES at Step S101), the process proceeds to Step S103.

Then, at Step S103, the accepting unit 511 determines whether the second password β2 has been accepted or not.

When the accepting unit 511 has determined that the second password β2 has not been accepted (NO at Step S103), the process becomes the standby state. When the accepting unit 511 has determined that the second password β2 has been accepted (YES at Step S103), the process proceeds to Step S105.

Then, at Step S105, the authentication unit 512 reads the first password β1 that corresponds to the second user ID α2 from the account storage unit 521. The first password β1 is associated with the first user ID α1 to be preliminarily stored in the account storage unit 521. The first user ID α1 and the first password β1 correspond to the first account information AC1.

Subsequently, at Step S107, the authentication unit 512 determines whether the second password β2 matches the first password β1 or not.

When the authentication unit 512 has determined that the second password β2 matches the first password β1 (YES at Step S107), the process proceeds to Step S109.

Then, at Step S109, the authentication unit 512 determines that the user authentication has succeeded, permits the login of the user to the image forming apparatus 100, and then the process terminates.

When the authentication unit 512 determines that the second password β2 does not match the first password β1 (NO at Step S107), the process proceeds to Step S111.

Then, at Step S111, the authentication unit 512 determines that the user authentication has failed.

Subsequently, at Step S113, the inhibition unit 513 determines whether the accepting unit 511 has accepted the second user ID α2 and the second password β2 from the touch panel 41 or not.

When it is determined that the accepting unit 511 has not accepted the second user ID α2 and the second password β2 from the touch panel 41 (NO at Step S113), the process proceeds to Step S117. When it is determined that the accepting unit 511 has accepted the second user ID α2 and the second password β2 from the touch panel 41 (YES at Step S113), the process proceeds to Step S115.

Then, at Step S115, the inhibition unit 513 determines whether the count NF is equal to or more than the first count NF1 or not. The count NF indicates a count where the user authentication has continuously failed.

When the inhibition unit 513 determines that the count NF is equal to or more than the first count NF1 (YES at Step S115), the process proceeds to Step S119 in FIG. 8. When the inhibition unit 513 determines that the count NF is not equal to or more than the first count NF1 (NO at Step S115), the process returns to Step S103.

In a case of NO at Step S113, after determining that the accepting unit 511 has accepted the second user ID α2 and the second password β2 from the personal computer 200, the inhibition unit 513, at Step S117, determines whether the count NF is equal to or more than the second count NF2 or not.

When the inhibition unit 513 determines that the count NF is equal to or more than the second count NF2 (YES at Step S117), the process proceeds to Step S119 in FIG. 8. When the inhibition unit 513 determines that the count NF is not equal to or more than the second count NF2 (NO at Step S117), the process returns to Step S103.

In a case of YES at Step S115 or in a case of YES at Step S117, as illustrated in FIG. 8, the inhibition unit 513, at Step S119, inhibits the acceptance of the second password β2 by the accepting unit 511.

Subsequently, at Step S121, the changing unit 514 changes the first password β1 to a new first password β1.

Subsequently, at Step S123, the changing unit 514 stores the new first password β1 in the account storage unit 521. Specifically, the changing unit 514 associates the new first password β1 with the first user ID α1 to store in the account storage unit 521.

Subsequently, at Step S125, the notification unit 515 notifies the user corresponding to the first user ID α1 of the new first password β1. Specifically, the notification unit 515 notifies the personal computer 200, which is used by the user corresponding to the first user ID α1, of the new first password β1.

Subsequently, at Step S127, the control unit 5 permits the accepting unit 511 to accept a new second password β2, and then the process returns to Step S101 in FIG. 7.

Steps S101 and S103 correspond to an exemplary “acceptance step.” Steps S105, S107, S109, and S111 correspond to an exemplary “authentication step.” Steps S113, S115, S117, and S119 correspond to an exemplary “inhibition step.”

As described above with reference to FIGS. 1 to 8, in the embodiment of the disclosure, the first account information AC1 and the second account information AC2 each include the user ID information and the password information. Then, when the inhibition unit 513 inhibits the accepting unit 511 from accepting the second password β2, the changing unit 514 changes the first password β1 to a new first password β1 and causes the notification unit 515 to notify the user corresponding to the first user ID α1 of the new first password β1. Consequently, even when the inhibition unit 513 inhibits the acceptance of the second password β2 by the accepting unit 511, the user can perform the user authentication using the new second password β2.

While the embodiment of the disclosure has been described above with reference to the drawings, the disclosure is not limited to the embodiment described above and is implemented in various kinds of aspects (for example, (1) to (3) described below) without departing from the gist of the disclosure. The drawings schematically illustrate respective components mainly for easy understanding. Accordingly, the thickness, length, number, and similar factor of the illustrated respective components are sometimes different from the actual thickness, length, number, and similar factor for the convenience of preparing the drawings. The shapes, dimensions, and similar factor of the respective components described in the embodiment described above are merely one example and are not particularly limited. Thus, they are variously changeable without substantially departing from the configuration of the disclosure.

(1) While, as described with reference to FIG. 1, in the embodiment of the disclosure, a “terminal device” is the personal computer 200, the disclosure is not limited to this. It is only necessary that the “terminal device” is communicatively connected to the image forming apparatus 100. “The terminal device” may be, for example, a smart phone and may also be a tablet terminal.

(2) While, as described with reference to FIGS. 1 to 3, in the embodiment of the disclosure, the accepting unit 511 accepts the second account information AC2 from the touch panel 41, the disclosure is not limited to this. It is only necessary that the accepting unit 511 accepts the second account information AC2 from the operation panel 4. For example, the accepting unit 511 may be configured to accept the second account information AC2 via hardware keys arranged in the operation panel 4.

(3) While, as described with reference to FIGS. 1 to 3, in the embodiment of the disclosure, the first account information AC1 is configured of the first user ID information α1J and the first password information β1J, and the second account information AC2 is configured of the second user ID information α2J and the second password information β2J, the disclosure is not limited to this. For example, the first account information AC1 may be configured to further include first passcode information, and the second account information AC2 may be configured to further include second passcode information. This configuration ensures further improvement of security of the image forming apparatus 100.

The disclosure is applicable to an image forming apparatus and a field of an authentication method that the image forming apparatus executes.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus that is communicatively connected to a terminal device, comprising:
an operation panel;
a storage unit that stores first account information;
an accepting unit that accepts second account information from the operation panel or the terminal device;
an authentication unit that performs a user authentication based on the first account information and the second account information; and
an inhibition unit that inhibits an acceptance of the second account information by the accepting unit when a count where the user authentication has continuously failed is equal to or more than an upper limit count; wherein
the upper limit count includes a first count and a second count,
the first count indicates the upper limit count where the accepting unit accepts the second account information from the operation panel,
the second count indicates the upper limit count where the accepting unit accepts the second account information from the terminal device, and
the first count is different from the second count.

2. The image forming apparatus according to claim 1, wherein the first count is larger than the second count.

3. The image forming apparatus according to claim 1, wherein when the accepting unit accepts the second account information from the operation panel, the inhibition unit permits the acceptance of the second account information by the accepting unit.

4. The image forming apparatus according to claim 1, wherein:
the operation panel includes a touch panel; and
the accepting unit accepts the second account information from the touch panel.

5. The image forming apparatus according to claim 4, wherein:
the touch panel displays an on-screen keyboard; and
the accepting unit accepts the second account information via the on-screen keyboard.

6. The image forming apparatus according to claim 1, wherein:
the first account information and the second account information include password information; and
the image forming apparatus further comprises
a changing unit that changes the password information to new password information when the inhibition unit inhibits the acceptance of the second account information by the accepting unit, and
a notification unit that notifies a user corresponding to the first account information of the new password information.

7. An image forming method executed by an image forming apparatus communicatively connected to a terminal device and including an operation panel and a storage unit that stores first account information, the image forming method comprising:
accepting second account information from the operation panel or the terminal device;
performing a user authentication based on the first account information and the second account information; and
inhibiting an acceptance of the second account information by the accepting when a count where the user authentication has continuously failed is equal to or more than an upper limit count; wherein
the upper limit count includes a first count and a second count,
the first count indicates the upper limit count of accepting the second account information from the operation panel,
the second count indicates the upper limit count of accepting the second account information from the terminal device, and
the first count is different from the second count.
